(19) United States
(12) Patent Application Publication
(10) Pub. No.: US 2014/0120301 A1
(43) Pub. Date: May 1, 2014

(54) SHEATHING ASSEMBLIES AND METHODS FOR MAKING AND USING SAME

(71) Applicant: Georgia-Pacific Wood Products LLC, Atlanta, GA (US)

(72) Inventors: Richard David Jordan, Lawrenceville, GA (US); Michael Eugene Carroll, Loganville, GA (US)

(73) Assignee: Georgia-Pacific Wood Products LLC, Atlanta, GA (US)

(21) Appl. No.: 14/065,580

(22) Filed: Oct. 29, 2013

Related U.S. Application Data
(60) Provisional application No. 61/721,046, filed on Nov. 1, 2012.

(51) Int. Cl. B32B 7/12; B32B 5/02; B32B 5/12

(52) U.S. Cl. CPC B32B 7/12; B32B 5/12; B32B 5/024; B32B 5/022
USPC 428/106; 428/221; 442/200; 442/364; 156/60

(57) ABSTRACT

Sheathing assemblies and methods for making and using same are provided. The sheathing assembly can include a body and a barrier secured to a first side of the body. The body can include a plurality of lignocellulosic substrates. Any adhesive disposed between the body and the barrier can consist of: (1) a first adhesive disposed throughout the body and having a substantially constant concentration within the body, (2) a second adhesive disposed throughout the barrier and having a substantially constant concentration within the barrier, or (3) a first adhesive disposed throughout the body and having a substantially constant concentration within the body and a second adhesive disposed throughout the barrier and having a substantially constant concentration within the barrier.

### CROSS-REFERENCE TO RELATED APPLICATION

This application claims priority to U.S. Provisional Patent Application having Ser. No. 61/721,046, filed Nov. 1, 2012, which is incorporated by reference herein.

### BACKGROUND

1. Field

Embodiments described herein generally relate to sheathing assemblies and methods for making and using same.

2. Description of the Related Art

Panels are typically installed on the exterior of a building's frame, e.g., the sides and roof of the building. The panels are then usually covered with a layer of material (“building wrap”) that can reduce the effects of the outside environment on the panels and the interior of the building. For example, the building wrap can serve as a barrier to protect the panels and the interior of the building from the penetration of water and/or snow.

Installation of the building wrap typically requires unrolling the building wrap from a roll and securing the building wrap to the panels via fasteners such as staples, adhesives, nails, or the like. Installing the building wrap, however, is often difficult and time consuming because the building wrap is typically provided as rolls that can be difficult to maneuver by workers on scaffolding and/or in windy conditions. Additionally, installing the building wrap can be made more difficult by environmental conditions (e.g., presence of water and/or debris). The difficulty presented in installing the building wrap, in addition to other factors, can lead to the building wrap being poorly secured or fastened to the panels. In such a case, the building wrap may become detached, thereby allowing the penetration of water and presenting a hazard to workers walking atop the panels.

There is a need, therefore, for improved panels installed about an exterior of a building's frame that are capable of reducing the effects of the outside environment on the panels and the interior of the building and/or that exhibit one or more improved characteristics, e.g., skid resistance.

### SUMMARY

Sheathing assemblies and methods for making and using same are provided. In at least one specific embodiment, the sheathing assembly can include a body and a barrier secured to a first side of the body. The body can include a plurality of lignocellulosic substrates. Any adhesive disposed between the body and the barrier can consist of: (1) a first adhesive disposed throughout the body and having a substantially constant concentration within the body, (2) a second adhesive disposed throughout the barrier and having a substantially constant concentration within the barrier, or (3) a first adhesive disposed throughout the body and having a substantially constant concentration within the body and a second adhesive disposed throughout the barrier and having a substantially constant concentration within the barrier.

In at least one other specific embodiment, the sheathing assembly can include a body and a barrier secured to a first side of the body. The body can include a plurality of lignocellulosic substrates and an adhesive. A concentration of the adhesive can be substantially constant throughout the body. The barrier can include a mixture of cellulosic fibers and polymer fibers. The cellulosic fibers can be present in an amount of about 5 wt % to about 95 wt % based on the combined weight of the cellulosic fibers and the polymer fibers. The polymer fibers can include bicomponent polymer fibers. Any adhesive disposed between the body and the barrier can consist of: (1) the first adhesive, (2) a second adhesive disposed throughout the barrier and having a substantially constant concentration within the barrier, or (3) the first adhesive and a second adhesive disposed throughout the barrier and having a substantially constant concentration within the barrier. A peel strength between the barrier and the body can be at least 0.0009 kgf/cm to about 2 kgf/cm, as measured according to ASTM D6862.

In at least one specific embodiment, the method for making a sheathing assembly can include locating a barrier and a body proximate one another and pressing the barrier and the body together to at least partially secure the barrier to the body to form a sheathing assembly. The body can include a plurality of lignocellulosic substrates. Any adhesive disposed between the body and the barrier can consist of: (1) a first adhesive disposed throughout the body and having a substantially constant concentration within the body, (2) a second adhesive disposed throughout the barrier and having a substantially constant concentration within the barrier, or (3) a first adhesive disposed throughout the body and having a substantially constant concentration within the body and a second adhesive disposed throughout the barrier and having a substantially constant concentration within the barrier.

### BRIEF DESCRIPTION OF THE DRAWINGS

FIG. 1 depicts an isometric view of an illustrative sheathing assembly, according to one or more embodiments described.

FIG. 2 depicts an illustrative cross-sectional view of another sheathing assembly, according to one or more embodiments described.

### DETAILED DESCRIPTION

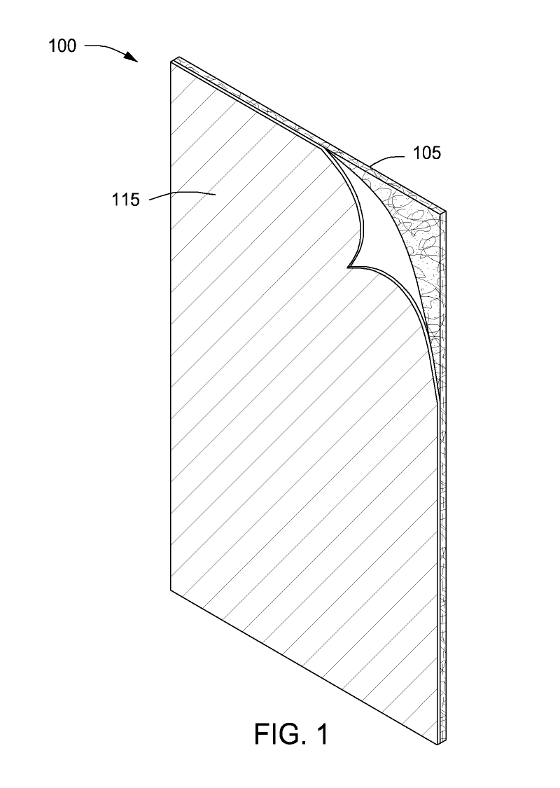

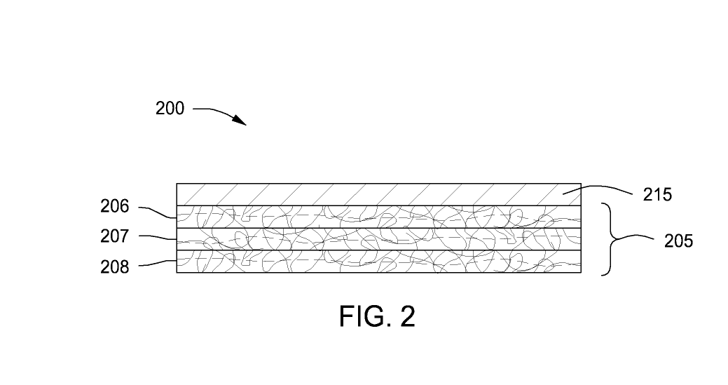

FIG. 1 depicts an isometric view of an illustrative sheathing assembly 100, according to one or more embodiments. As shown in FIG. 1, the sheathing assembly 100 can include two or more layers of material (two are shown 105, 115). A first layer or barrier 115, and a second layer or body 105, can be joined, coupled, combined, contacted, affixed, connected, or otherwise at least partially secured to one another to form or produce the sheathing assembly 100. Each layer 105, 115 can be a single layer of material or two or more layers of materials. For example, FIG. 2 depicts another illustrative sheathing assembly that includes a body 205 and a barrier 215, where the body 205 includes a first layer 206, a second layer 207, and a third layer 208. Similar to the body 205, the barrier 115 and/or 215 can also include a plurality of layers.

If the body 105, 205 and/or the barrier 115, 215 include two or more layers, each of the two or more layers can be made from the same material(s) or different material(s) with respect to one another. The body 105, 205 can be a composite made from a plurality of substrates bound to one another with one or more binders or resins. The plurality of substrates can be substantially aligned in the body 105, 205, thereby providing a directional orientation for the body 105, 205, or the plurality of substrates can be randomly oriented. The substrates can be derived from any number of materials or combinations of materials. Materials from which the substrates can be derived can include, but are not limited to, glass, carbon, lignocellulose, polymers, gypsum, metal, cement, or any mixture or combination thereof. The starting material, from which the substrates can be derived, can be shaped, reduced, or otherwise formed to the appropriate dimensions by various processes such as hogging, grinding, hammer milling, tearing, shredding, and/or flaking. Other processes for producing the substrates can include skiving, cutting, slicing, and/or sawing. Suitable forms of the substrates can include, but are not limited to, particles, chips, flakes, wafers, fibers, powder, shavings, strands, sawdust or dust, veneer, strands, and/or the like. In at least one embodiment, the body 105, 205 can be a lignocellulose composite product. In another embodiment, the body 105, 205 can be a gypsum composite, such as a gypsum board, or drywall, or sheetrock.

Specific lignocellulose composite products can include engineered products, e.g., engineered wood products. Engineered wood products can include a plurality of substrates composed of wood and/or other lignocellulose materials and one or more adhesives (“first adhesives”) to bind, couple, bond, affix, or otherwise join the plurality of substrates to one another to form the engineered product. Illustrative engineered wood products can include, but are not limited to, particleboard, fiberboard such as medium density fiberboard (“MDF”) and/or high density fiberboard (“HDF”), waferboard, oriented strand board plywood (“OSB”), plywood, laminated veneer lumber (“LVL”), laminated veneer boards (“LVB”), engineered wood flooring, and the like. Any suitable adhesive can be used to bind or join the substrates to one another to produce the body 105, 205. In one or more embodiments, the barrier 115 and/or 215 can be also include of a plurality of substrates. If the barrier 115, 215 includes a plurality of substrates one or more adhesives (“second adhesives”) can be used to bind, couple, bond, affix, or otherwise join the plurality of substrates to one another to form the barrier 115, 215. As used herein, the terms “adhesive,” “binder,” “resin,” and “glue” are used interchangeably and refer to a composition that can be mixed, blended, or otherwise contacted with a plurality of substrates and at least partially cured to form the body 105, 205, the barrier 115, 215, and/or the sheathing assembly 100, 200. Illustrative adhesives can include, but are not limited to, isocyanate resin, aldehyde based resins such as urea-formaldehyde, phenol formaldehyde, melamine formaldehyde, phenol-urea-formaldehyde resin, resorcinol-formaldehyde resin, phenol-resorcinol-formaldehyde resin, and melamine-urea-formaldehyde resin, oxidative binder compositions that can include be formed by contacting one or more free radical precursors with the lignocellulose substrates and optionally one or more polyphenolic compounds, or any mixture thereof. Suitable oxidative binder compositions can be as discussed and described in U.S. Provisional Patent Application having Ser. No. 61/708,395, filed on Oct. 1, 2012.

As previously discussed, the body 105, 205 can include two or more layers of material. In at least one embodiment, shown in FIG. 2, the two or more layers of material can include one or more core or inner layers (one is shown 207) interposed between two outer or face layers 206, 208. Each of the layers 206, 207, 208 of a multi-layer body 205 can be oriented in one or more directions with respect to one another. For example, the plurality of substrates forming the core layer 207 can be oriented in a first direction while the plurality of substrates forming the outer or “face” layers 206, 208 can be oriented perpendicular to the plurality of substrates forming the core layer 207. Each layer 206, 207, 208 can further include the same adhesive or different adhesive with respect to one another. For example, the body 205 can be or include OSB made from pressed strands of wood arranged in three distinct layers 206, 207, 208 with the strands of the outer layers 206, 208 oriented perpendicularly to the strands of the inner layer 207. The strands of the layers 206, 207, 208 can be bonded to one another by contacting the strands with the adhesive and at least partially curing the adhesive. Exemplary commercially available materials suitable for the body 105, 205 can include, but is not limited to, Blue Ribbon® OSB Rated Sheathing, Blue Ribbon® Sturd-I-Floor® Sub-floor, Thermostat® OSB Radiant Barrier Sheathing, Thermostat® plywood Radiant Barrier Sheathing, Plytanium® plywood, Plytanium® Sturd-I-Floor® plywood, DensGlass™ exterior sheathing, and DensDeck® roof boards, each sold by the Georgia-Pacific Corporation.

The concentration of the adhesive in each layer 206, 207, 208 of the body 205 can be the same or different with respect to one another. The concentration of the adhesive in each respective layer 206, 207, 208 can also be substantially constant throughout each respective layer 206, 207, 208. For example, in at least one embodiment, the core layer 207 can have a higher concentration of the adhesive with respect to the outer layers 206, 208. Alternatively, the outer layers 206, 208 can have a higher concentration of the adhesive with respect to the core layer 207. In at least one embodiment, the concentration of the adhesive in a first outer layer 206 can be the same or different with respect to the second outer layer 208.

The bodies 105, 205 and the barriers 115, 215, respectively, can be at least partially secured to one another to form the sheathing assembly 100, 200 via any suitable method. The conventional or known methods for making sheathing assemblies having a barrier 115, 215 coupled to a body 105, 205 requires the addition of an adhesive layer (e.g., binder or resin), also frequently referred to as a “glue line” between the body 105, 205 and the barrier 115, 215.

It has been surprisingly and unexpectedly discovered that the body 105, 205 and the barrier 115, 215 can be at least partially secured to one another without any added binder or resin disposed between the barrier 115, 215 and its corresponding body 105, 205. Indeed, prior to the present invention, it was believed that a binder or resin had to be applied between the body 105, 205 and the corresponding barrier 115, 215. Such an adhesive layer is not required to at least partially secure the barrier 115, 215 to the corresponding body 105, 205 to form the sheathing assemblies 100, 200. Said another way, the sheathing assemblies 100, 200 can be made without any additional adhesive added between the barrier 115, 215 and the corresponding body 105, 205. As such, the one or more methods of making or forming the sheathing assemblies 100, 200, discussed and described herein, can avoid or omit the step of applying any additional adhesive between the barrier and the body as required in the prior art. As such, the sheathing assemblies 100, 200 can have a binder or resin concentration from the surface of the barrier 115, 215 in contact with the body 105, 205 through the body 105, 205 or at least the first layer 206 of body 205 that is constant or substantially constant. Likewise, if a second adhesive is present in the barrier 115 and/or 215, the sheathing assemblies 100, 200 that include such a barrier can have a binder or resin concentration from the surface of the body 105, 205 through the barrier 115, 215 that is constant or substantially constant. Similar to a multi-layered body 205, if the barrier 115, 215 is composed of multiple layers, the second adhesive, if present in the barrier 115, 215 can have a binder or resin concentration from the surface of the body 105, 205 through the barrier 115, 215 or at least through the layer of the barrier 115, 215 in contact with the body 105, 205 that is constant or substantially constant.

When the adhesive concentration is substantially constant for any given volume defined from the location where the surface of the barrier 115, 215 contacts the body 105, 205 and into or through the body 105, 205 or at least the first layer 206 of body 205 the adhesive concentration can vary by less than 80%, less than 60%, less than 40%, less than 20%, less than, 15%, less than 10%, less than 5%, less than 4.5%, less than 4%, less than 3.5%, less than 3%, less than 2.5%, less than 2%, less than 1.5%, or less than 1%. For example, if the concentration of the adhesive is 0.1 g per 0.1 cm³ of the body 105, 205 at a first region located at the interface between the barrier 115 and the body 105, i.e., where the barrier 115 contacts the body 105, the concentration of the binder or resin at any other location within the body 105, e.g., the middle of the body 105, 205 or the opposing side of the body 105, would be within +/−5% of 0.1 g per 0.1 cm³ of the body 105, i.e., from 0.095 g per cm³ of the body 105 to 0.105 g per cm³ of the body.

In at least one embodiment, a total concentration of adhesive in the sheathing assembly 100 and/or 200 can be measured by the total concentration of the adhesive in the single layer making up the body 105 or all the layers 206, 207, 208 making up the body 205 combined. In another embodiment, a total concentration of adhesive in the sheathing assembly 100 and/or 200 can be measured by the total concentration of the adhesive in the single layer making up the barrier 215, the body 205, or the individual layers thereof making up the barrier 215 and/or the body 205 combined. Further, the total concentration of adhesive in the sheathing assembly 100 and/or 200 can be less than the total concentration of adhesive in comparative sheathing assemblies having the same barrier and body, but further having an additional adhesive present to secure the body to the barrier because the additional adhesive or “glue line” required in the prior art to be applied between the barrier and the body is not present in the sheathing assemblies 100 and 200 discussed and described herein. In addition to being free from any separate or distinct adhesive between the barrier 115, 215 and the body 105, 205, the sheathing assembly can also be free from any mechanical fasteners. Illustrative mechanical fasters include staples, nails, screws, rivets, clamps, or the like. In terms of total amount of adhesive, the body 105, 205 can contain a first amount of adhesive and the barrier 115, 215 can contain a second amount of adhesive, where the total amount of adhesive in the body 105, 205, the barrier 115, 215, and any adhesive located between the interface consists only of the first amount of adhesive and the second amount of adhesive. Said another way, the sheathing assembly 100, 200 can be free from any added glue line between the barrier 115, 215 and the body 105, 205.

Considering the barriers 115, 215 in more detail, the term “barrier” as used herein, refers to any material that is able to at least partially resist air, water, moisture, light, pests, or any other desired environmental element or concerns, or any combination of environmental elements or concerns. The barrier 115, 215 can be in the form of one or more films, sheets, mats, or the like, or any combination thereof. The barrier 115, 215 can have a solid or substantially solid structure, e.g., a polymer film, and/or a porous structure, e.g., a woven and/or non-woven mat of fibers. The barrier 115, 215 can also be perforated or non-perforated. Perforations can be formed by weaving multiple fibers or strands, mechanical formation of holes, or a combination thereof. Said another way, the barrier 115, 215 can be selectively permeable and can prevent or reduce a rate at which liquid water passes therethrough while allowing water vapor to pass therethrough. The barrier 115, 215 can also be or include materials referred to in the art as a “building wrap” or “house wrap” that can be applied to the body 105, 205 before the application of a final siding or veneer, e.g., brick, metal, painted wood, stucco, vinyl siding, cellulose fiber reinforced cement boards, Exterior Insulation and Finish System (“EIFS”), and the like. Commercially available barriers 115, 215 can include, but are not limited to, GreenGuard® Value Building Wrap™ and GreenGuard® Max Building Wrap™, each sold by the Pactiv Corporation.

Suitable materials for forming a solid structure and/or a woven or non-woven barrier 115, 215 can include, but are not limited to, cellulosic material(s), polymeric material(s), glass, carbon, metal (e.g., aluminum foil, flakes, strands, and/or powder), hydrocarbons (e.g. tar paper), felt, resin impregnated papers, or combinations thereof. In at least one embodiment, the barrier 115, 215 and/or one or more individual layers of the barrier 115, 215 can include one or more cellulosic fibers, one or more polymer fibers, and, optionally, one or more additives. Illustrative resin impregnated papers can include paper impregnated with phenol-formaldehyde resin, modified phenol-formaldehyde resin, or other suitable resin. The barrier 115, 215 and/or one or more individual layers of the barrier 115, 215 can be or include a hydrophobic material and/or a hydrophilic material. Barriers 115, 215 composed of a mixture or combination of cellulosic fibers and polymer fibers can also be referred to as “airlaid” sheets or mats. One particularly suitable barrier can be or include an air-laid sheet or mat composed of cellulosic fibers and/or polymer fibers.

Conventional airlaid material is highly water absorbent. It has been surprisingly and unexpectedly discovered, however, that the airlaid materials discussed and described herein can be transformed into liquid water resistant sheets having desirable air and/or water vapor permeability properties by pressing and/or heating the airlaid material under sufficient conditions. For example, an airlaid material can be subjected to a pressure from a low of about 0.5 kPa, about 1 kPa, about 2 kPa, about 3 kPa, or about 4 kPa to a high of about 3 kPa, about 4 kPa, about 5 kPa, about 8 kPa, or about 10 kPa, about 15 kPa, or more. The airlaid material can be heated to a temperature from a low of about 200° C., about 250° C., about 300° C., about 350° C., about 375° C., about 400° C., or about 450° C., to a high of about 350° C., about 400° C., about 425° C., about 450° C., about 475° C., about 500° C., or about 550° C. The airlaid material can be subjected to both heat and pressure simultaneously or during different steps. The airlaid material can be subjected to pressure and/or heat alone to form a compressed airlaid sheet and the compressed airlaid sheet can be located onto the body. The airlaid sheet can be located onto the body and can be pressed and/or heated in conjunction with the body. The airlaid material can also be located onto the body and can be pressed and/or heated in conjunction with the body to form the compressed airlaid sheet and couple the airlaid sheet to the body.

The barrier layer 115, 215, after at least partially secured to the body 105, 205 can have a water vapor transmission rate (“WVTR”) from a low of about 0.1 g/m²/24 hrs, about 0.2 g/m²/24 hrs, about 0.4 g/m²/24 hrs, about 0.6 g/m²/24 hrs, about 0.8 g/m²/24 hrs, about 1.0 g/m²/24 hrs, about 1.2 g/m²/24 hrs, or about 1.5 g/m²/24 hrs, to a high of 4.0 g/m²/24 hrs, about 5.0 g/m²/24 hrs, about 6.0 g/m²/24 hrs, about 6.5 g/m²/24 hrs, about 7.0 g/m²/24 hrs, about 7.5 g/m²/24 hrs, about 8.5 g/m²/24 hrs, or about 9.0 g/m²/24 hrs at 22.8° C. and 50% relative humidity (RH) according to ASTM E96 procedure A. For example, the barrier 115, 215 can have a WVTR of about 0.1 g/m²/24 hrs to about 8.0 g/m²/24 hrs, about 0.4 g/m²/24 hrs to about 7.0 g/m²/24 hrs, or about 0.6 g/m²/24 hrs to about 6.5 g/m²/24 hrs at 22.8° C. and 50% RH, according to ASTM E96 procedure A. The barrier layer 115, 215 can have a liquid water transmission rate (“LWTR”) from a low of about 0.5 g/m²/24 hrs, about 1.0 g/m²/24 hrs, about 2.0 g/m²/24 hrs, about 3.0 g/m²/24 hrs, about 4.0 g/m²/24 hrs, or about 5.0 g/m²/24 hrs, to a high of about 20 g/m²/24 hrs, about 1.0 g/m²/24 hrs, about 22 g/m²/24 hrs, about 25 g/m²/24 hrs, about 28 g/m²/24 hrs, or about 32 g/m²/24 hrs, via a Cobb ring according to ASTM D5795. For example, the barrier 115, 215 can have a LWTR of about 1.0 g/m²/24 hrs to about 28 g/m²/24 hrs, about 2.0 g/m²/24 hrs to about 25 g/m²/24 hrs, or about 3.0 g/m²/24 hrs to about 22 g/m²/24 hrs via a Cobb ring according to ASTM D5795.

The barrier 115, 215, prior to at least partially securing to the body 105, 205, can have the same WVTR and/or LWTR rate as the barrier 115, 215 after securing or different. For example, the barrier 115, 215 before at least partially secured to the body 105, 205, can have a WVTR from a low of about 0.1 g/m²/24 hrs, about 0.4 g/m²/24 hrs, about 0.4 g/m²/24 hrs, about 0.6 g/m²/24 hrs, about 0.8 g/m²/24 hrs, about 1.0 g/m²/24 hrs, about 1.2 g/m²/24 hrs, or about 1.5 g/m²/24 hrs, to a high of 4.0 g/m²/24 hrs, about 5.0 g/m²/24 hrs, about 6.0 g/m²/24 hrs, about 6.5 g/m²/24 hrs, about 7.0 g/m²/24 hrs, about 7.5 g/m²/24 hrs, about 8.5 g/m²/24 hrs, or about 9.0 g/m²/24 hrs at 22.8° C. and 50% RH, according to via ASTM E96 procedure A. For example, the barrier 115, 215, prior to securing to the body 105, 205, can have a WVTR of about 0.1 g/m²/24 hrs to about 8.0 g/m²/24 hrs, about 0.4 g/m²/24 hrs to about 7.0 g/m²/24 hrs, or about 0.6 g/m²/24 hrs to about 6.5 g/m²/24 hrs 22.8° C. and 50% RH, according to via ASTM E96 procedure A. The barrier layer 115, 215, prior to at least partially securing to the body 105, 205, can have a LWTR a low of about 0.5 g/m²/24 hrs, about 1.0 g/m²/24 hrs, about 2.0 g/m²/24 hrs, about 3.0 g/m²/24 hrs, about 4.0 g/m²/24 hrs, or about 5.0 g/m²/24 hrs, to a high of about 20 g/m²/24 hrs, about 1.0 g/m²/24 hrs, about 22 g/m²/24 hrs, about 25 g/m²/24 hrs, about 28 g/m²/24 hrs, or about 32 g/m²/24 hrs via a Cobb ring according to ASTM D5795. For example, the barrier 115, 215, before at least partially secured to the body 105, 205, can have a LWTR of about 1.0 g/m²/24 hrs to about 28 g/m²/24 hrs, about 2.0 g/m²/24 hrs to about 25 g/m²/24 hrs, or about 3.0 g/m²/24 hrs to about 22 g/m²/24 hrs via a Cobb ring according to ASTM D5795.

Suitable cellulosic materials can include, but are not limited to, cotton fibers, lignocellulose fibers, pulp fibers, or any mixture thereof. Cellulosic fibers include lignin, cellulose, and hemi-cellulose material. Pulp fibers can include cellulosic fibers in which at least a portion of the lignin has been removed to produce a material that is more hydrophilic than cellulosic fibers. For example, in the pulp and paper industry, lignin-containing materials such as wood, straw, corn stalks, bagasse, and other vegetable and plant tissues can be processed to recover the cellulose or pulp via the well known kraft or sulfate process or the well known sulfite process. Exemplary pulp fibers can include, but are not limited to thermomechanical pulp fibers, chemithermomechanical pulp fibers, chemimechanical pulp fibers, refinermechanical pulp fibers, stone ground wood pulp fibers, peroxide mechanical pulp fibers, and the like.

Suitable processes for isolating or otherwise separating lignin or lignin containing products from wood, plant, vegetable, or other lignin containing matter can include those discussed and described in U.S. Pat. Nos. 1,856,567; 2,525,433; 2,680,113; 2,690,973; 3,094,515; 3,158,520; 3,503,762; 3,585,104; 3,726,850; 3,769,272; 3,841,887; 4,100,016; 4,131,564; 4,184,845; 4,308,203; 4,355,996; 4,470,876; 4,740,591; and 4,764,596; U.S. Patent Application Publication Nos.: 2011/0294991; and WO Publication Nos. WO1992/018557A1, WO1993/021260A2; WO1994/024192A1; WO2005/062800A2; WO2006/031 175 A1; and WO2011/150508.

The one or more polymeric materials from which the barrier 115, 215 can be at least partially composed of can include, but are not limited to, homopolymers and/or copolymers (including terpolymers) of C₂ to C₄₀ olefins, preferably C₂ to C₂₀ olefins. Illustrative polymers can include, but are not limited to, homo polyethylene, homo polypropylene, propylene copolymerized with ethylene and or butene, ethylene copolymerized with one or more of propylene, butene, hexene, octene, and optional dienes. Other illustrative polymers can include, but are not limited to, thermoplastic polymers such as ultra low density polyethylene, very low density polyethylene (“VLDPE”), linear low density polyethylene (“LLDPE”), low density polyethylene (“LDPE”), medium density polyethylene (“MDPE”), high density polyethylene (“HDPE”), polypropylene, isotactic polypropylene, highly isotactic polypropylene, syndiotactic polypropylene, random copolymer of propylene and ethylene and/or butene and/or hexene and/or octene, elastomers such as ethylene propylene rubber, ethylene propylene diene monomer rubber, neoprene, and blends of thermoplastic polymers and elastomers, such as for example, thermoplastic elastomers and rubber toughened plastics.

In at least one embodiment, the polymer fibers can be or include bicomponent fibers. Bicomponent fibers can include fibers produced or formed from two or more distinct or separate polymer components. For example, the two or more polymer components of the bicomponent fibers can have a side-by-side arrangement or a sheath/core arrangement. In a sheath/core arrangement, a first polymer component (e.g., core) can be surrounded by a second polymer component (e.g., sheath). The two or more polymer components can be arranged in substantially constant distinct zones across a cross-section of the bicomponent fiber. The distinct zones in which the polymer components can be arranged can extend along a portion of or the entire length of the fibers. Specific combinations of polymer components for the bicomponent fiber can include, but is not limited to sheath/core arrangements such as polyethylene/polypropylene, polyethylene/polyester, co-polyester/polyester, polypropylene/polyester, or the like.

One or more combinations or blends of polymers can be used for the first and second polymer components of the bicomponent fibers. The polymer for the bicomponent fibers can be selected from any one or more of the polymers discussed and described above. In at least one embodiment, the combination of the polymers used for the polymer components can determine or alter one or more properties of the bicomponent fibers, the barrier 115, 215, and/or the sheathing material 100. For example, varying the polymer components can increase or decrease the ability of the bicomponent fibers to bind or couple to other bicomponent fibers, cellulosic fibers, and/or one or more components that may be present in the barrier 115, 215, and/or the body 105, 205. In at least one embodiment, the first polymer component (e.g., core) can have a melting point higher than the melting point of the second polymer component (e.g., sheath). In another embodiment, the melting point of the first polymer component can be lower than the melting point of the second polymer component. In another embodiment, varying the bicomponent fiber can increase and/or decrease the permeability of the barrier 115, 215 and/or the sheathing material 100.

In a barrier 115, 215 made from a mixture of cellulosic fibers and polymer fibers, the concentration of the cellulosic fibers can be from a low of about 5 wt %, about 10 wt %, about 15 wt %, about 20 wt %, about 25 wt %, or about 50 wt %, to a high of about 50 wt %, about 60 wt %, about 70 wt %, about 80 wt %, about 90 wt %, or about 95 wt %, based on the combined weight of the cellulosic fibers and the polymer fibers. For example, a barrier 115, 215 that includes a mixture of cellulosic fibers and polymer fibers can have a cellulosic fiber concentration from about 5 wt % to about 95 wt %, about 15 wt % to about 90 wt %, about 20 wt % to about 80 wt %, about 25 wt % to about 70 wt %, or about 50 wt % to about 60 wt %, based on the combined weight of the cellulosic fibers and the polymer fibers.

In a barrier 115, 215 composed of a mixture of cellulosic fibers and polymer fibers, the ratio of the cellulosic fiber to the polymer fiber can be from a low of about 0.02, about 0.05, about 0.10, or about 0.5, to a high of about 10, about 15, about 20, or about 25, based on the combined weight of the cellulosic fibers and the polymer fibers in the barrier 115, 215. The ratio of cellulosic fiber to polymer fiber can be about 0.15, about 0.5, about 10, or about 20, based on the combined weight of the cellulosic fibers and the polymer fibers in the barrier 115, 215.

If the barrier 115, 215 includes two or more individual layers having a different composition or distribution of fibers as compared to one another, the concentration of the cellulosic fibers, the polymer fibers in each layer can be the same or different with respect to the other layers of the barrier 115, 215. Any of the one or more individual layers of the barrier 115, 215 can have a cellulosic fiber concentration from a low of about 5 wt %, about 10 wt %, about 15 wt %, about 20 wt %, about 25 wt %, or about 50 wt %, to a high of about 50 wt %, about 60 wt %, about 70 wt %, about 80 wt %, about 90 wt %, or about 95 wt % based on the combined weight of the cellulosic fibers in all the layers combined. In another example, any of the one or more individual layers of the barrier 115, 215 can have a cellulosic fiber concentration from about 5 wt % to about 95 wt %, about 15 wt % to about 90 wt %, about 20 wt % to about 80 wt %, about 25 wt % to about 70 wt %, or about 50 wt % to about 60 wt %, based on the combined weight of the cellulosic fibers in all the layers combined. Any of the one or more individual layers of the barrier 115, 215 can have a polymer fiber concentration from a low of about 5 wt %, about 10 wt %, about 15 wt %, about 20 wt %, about 25 wt %, or about 50 wt %, to a high of about 50 wt %, about 60 wt %, about 70 wt %, about 80 wt %, about 90 wt %, or about 95 wt %, based on the combined weight of the polymer fibers concentration in all the layers combined. In another example, any of the one or more individual layers of the barrier 115, 215 can have a polymer fiber concentration from about 5 wt %, about 10 wt %, about 15 wt %, about 20 wt %, about 25 wt %, or about 50 wt %, to a high of about 50 wt %, about 60 wt %, about 70 wt %, about 80 wt %, about 90 wt %, or about 95 wt %, based on the combined weight of the polymer fibers concentration in all the layers combined. In at least one specific embodiment, the barrier 115, 215 can have a first layer, a second layer, and a third layer (not shown). The first layer can have a cellulosic fiber concentration from about 5 wt %, about 10 wt %, about 15 wt %, about 20 wt %, about 25 wt %, or about 50 wt %, to a high of about 50 wt %, about 60 wt %, about 70 wt %, about 80 wt %, about 90 wt %, or about 95 wt % and a polymer fiber concentration from about 5 wt %, about 10 wt %, about 15 wt %, about 20 wt %, about 25 wt %, or about 50 wt %, to a high of about 50 wt %, about 60 wt %, about 70 wt %, about 80 wt %, about 90 wt %, or about 95 wt %. The second layer can have a cellulosic fiber concentration from about 5 wt %, about 10 wt %, about 15 wt %, about 20 wt %, about 25 wt %, or about 50 wt %, to a high of about 50 wt %, about 60 wt %, about 70 wt %, about 80 wt %, about 90 wt %, or about 95 wt % and a polymer fiber concentration from about 5 wt %, about 10 wt %, about 15 wt %, about 20 wt %, about 25 wt %, or about 50 wt %, to a high of about 50 wt %, about 60 wt %, about 70 wt %, about 80 wt %, about 90 wt %, or about 95 wt %. The third layer can have a cellulosic fiber concentration from about 5 wt %, about 10 wt %, about 15 wt %, about 20 wt %, about 25 wt %, or about 50 wt %, to a high of about 50 wt %, about 60 wt %, about 70 wt %, about 80 wt %, about 90 wt %, or about 95 wt % and a polymer fiber concentration from about 5 wt %, about 10 wt %, about 15 wt %, about 20 wt %, about 25 wt %, or about 50 wt %, to a high of about 50 wt %, about 60 wt %, about 70 wt %, about 80 wt %, about 90 wt %, or about 95 wt %.

Any of the one or more individual layers of the barrier 115, 215 can have a ratio of cellulosic fiber to polymer fiber from a low of about 0.02, about 0.05, about 0.10, or about 0.5, to a high of about 10, about 15, about 20, or about 25, based on the combined weight of the cellulosic fibers and the polymer fibers in each of the respective one or more individual layers. The ratio of cellulosic fiber to polymer fiber can be about 0.15, about 0.5, about 10, or about 20, based on the combined weight of the cellulosic fibers and the polymer fibers in each of the respective one or more individual layers.

In one or more embodiments, varying the concentration or ratio of the cellulosic fibers to the polymer fibers can control, adjust, or otherwise affect one or more properties of the barrier 115, 215. For example, the amount of polymer fibers can increase the tackiness or adhesive properties of the barrier 115, 215 when heated to a sufficient temperature because the polymer fibers can at least partially soften or melt and when cooled can hold or otherwise secure the cellulosic fibers and the polymer fibers to one another. As such, decreasing the ratio of the polymer fibers to the cellulosic fibers in the barrier 115, 215 or in an outermost layer of a multi-layer barrier (not shown) can reduce the likelihood that the barrier 115, 215 will adhere to a press platen or roller during one or more heating and/or pressing processes discussed and described herein. Additionally, increasing the ratio of the polymer fibers to the cellulosic fibers in the barrier 115, 215 or in an innermost layer of a multi-layer barrier, i.e., the later of the barrier that contacts the body 105, 205 (not shown), can increase the coupling force between the barrier and the body upon pressing and/or heating the two while in contact with one another. In another example, increasing the concentration of cellulosic fibers, e.g., pulp fibers, can increase the absorbency in the barrier 115, 215

In at least one embodiment, varying the concentration of the bicomponent fibers in the barrier 115, 215 can facilitate the assembly or fabrication of the sheathing assembly 100 discussed and described herein. For example, varying the concentration of the bicomponent fibers in the barrier 115, 215 can reduce the adhesion of the barrier 115, 215 to the heated press or roller and/or reduce the tearing of the fibers during one or more heating and pressing processes.

In a typical barrier 115, 215 made from a mixture of cellulosic fibers and bicomponent fibers, the bicomponent fibers can be present or have a concentration in the barrier 115, 215 from about 5 wt %, about 10 wt %, about 15 wt %, about 20 wt %, about 25 wt %, or about 50 wt %, to a high of about 50 wt %, about 60 wt %, about 70 wt %, about 80 wt %, about 90 wt %, or about 95 wt %, based on the combined weight of the bicomponent fibers and the cellulosic fibers. The barrier 115, 215 discussed and disclosed herein can have bicomponent fibers at a concentration from a low of about 5 wt %, about 10 wt %, about 15 wt %, about 20 wt %, about 25 wt %, or about 50 wt %, to a high of about 50 wt %, about 60 wt %, about 70 wt %, about 80 wt %, about 90 wt %, or about 95 wt %. In another embodiment, the barrier 115, 215 can have bicomponent fiber concentrations from about 5 wt % to about 95 wt %, about 15 wt % to about 90 wt %, about 20 wt % to about 80 wt %, about 25 wt % to about 70 wt %, or about 50 wt % to about 60 wt %.

As noted above, the polymer components of the bicomponent fibers can further include one or more additives. The additive(s) can provide the barrier 115, 215 with one or more additional properties. For example, the second polymer component, or sheath, can include an additive to increase or decrease the adhesion of the bicomponent fibers to one or more components (e.g. pulp fibers) of the barrier 115, 215 and/or one or more components of the sheathing assembly 100. In at least one embodiment, the inclusion of an additive can increase the performance of the barrier 115, 215 by reducing the steps required in fabricating the sheathing assembly 100. In at least another embodiment, the inclusion of an additive in the sheath material can also provide a cost effective method of fabricating or forming the sheathing assembly 100, 200, as the additive is made available in the surface of the fibers where the additive is likely to be utilized. Suitable additives can include, but are not limited to melt additives, latex binders, and/or binders or adhesives (“second adhesives”).

Referring generally to the fibers in general that can be used to make the barrier 115, 215, the length of the fiber can increase or decrease a level of entanglement between the fibers, thereby affecting the dispersion of the fibers in the barrier 115, 215. In at least one embodiment, the length of the fibers can be reduced or shortened through one or more processes to provide fibers having a desired length. The level of entanglement between the fibers can also increase or decrease the tensile strength of the barrier 115, 215. The fibers can be crimped or can maintain a columner configuration.

Suitable fibers for use in forming the barrier 115, 215 can have a decitex (dtex) from a low of about 1 g/10 km, about 2 g/10 km, about 3 g/10 km, about 6 g/10 km, or about 10 g/10 km, to a high of about 10 g/10 km, about 15 g/10 km, about 20 g/10 km, or about 25 g/10 km. For example, the fibers can have a dtex from about 1 g/10 km to about 25 g/10 km, about 2 g/10 km to about 20 g/10 km, about 3 g/10 km to about 15 g/10 km, or about 6 g/10 km to about 10 g/10 km.

Suitable fibers for use in forming the barrier 115, 215 can have a length from a low of about 1 mm, about 3 mm, about 5 mm, or about 7 mm, to a high of about 10 mm, about 12 mm, about 14 mm, or about 16 mm. For example, the fibers can have a length from about 1 mm to about 16 mm, about 3 mm to about 14 mm, or about 5 mm to about 12 mm.

In at least one embodiment, the barrier 115, 215 can be fabricated by blending the cellulosic fibers, bicomponent fibers, and/or an additive (e.g. a binder) at a desired weight ratio in a mixer. Mixing can include blending in an airstream or other mixing device. The mixture can then be formed into the barrier 115, 215 by conveying the mixture by air through a forming nozzle and feeding the mixture onto a forming surface, such as a wire screen or a drum former, to form a web or film of the mixture. A vacuum can also be included to further draw the mixture against the wire screen or drum former to form the web. The web can be further treated through one or more bonding processes to provide the barrier 115, 215.

Bonding the web to form the barrier 115, 215 can be achieved through one or more methods. In at least one embodiment, the methods of bonding the web can include subjecting the web to one or more pressing and/or heating processes. The method of bonding the fibers forming the web can also include the application of one or more additives (e.g. binder). For example, in at least one embodiment, the web can be pressed by one or more rollers to provide integrity and cohesiveness of the one or more components therein. In another embodiment, the one or more rollers can be heated to provide both heat and pressure to bond the web and form the barrier 115, 215. The methods of bonding can include, but is not limited to, at least partially curing an adhesive or binder mixed with the fibers, heating the fibers sufficiently to cause the polymer fibers to soften and/or at least partially melt, hydrogen-bonding, or any other suitable method.

If an adhesive is used to bond the fibers together to form the barrier 115, 215, the adhesive can be a thermosetting and/or thermoplastic adhesive. As such, curing the adhesive (thermosetting) can prevent subsequent softening or adhesion of the binder. For example, curing the adhesive of the web to form the barrier 115, 215 can prevent the adhesive from further bonding to the body 105, 205, even upon the application of heat and/or pressure. In another example, the adhesive can be only partially cured, e.g., B-staged and/or thermoplastic, thereby allowing the adhesive to participate, at least in part, in the subsequent securing of the barrier to the body 105, 205 upon application of heat, for example.

Hydrogen-bonding the web to form the barrier 115, 215 can include utilizing the ability of the cellulosic fibers to bond the components together when naturally occurring moisture contained in the fibers is removed while the fibers are in close contact. Similar to other bonding methods, hydrogen-bonding can include one or more heating and pressing processes. In at least one embodiment, the hydrogen-bonding method can be utilized to eliminate the need for polymer fibers.

Some commercially available materials that can be used as the barrier 115, 215 can include, but are not limited to, GreenGuard® Value Building Wrap™ and GreenGuard® Max Building Wrap™, each sold by the Pactiv Corporation.

At least partially securing the barrier 115, 215 to the body 105, 205 to make the sheathing assembly 100 can include contacting the barrier 115, 215 with the body 105, 205 and subjecting the contacted barrier and body to heat and/or pressure. In one or more embodiments, the barrier 115, 215 can be pre-pressed before contacting the barrier 115, 215 with the body 105, 205. For example, in at least one embodiment, the method can include providing the barrier 115, 215 and subjecting the barrier 115, 215 to a first heating and/or pressing process. The method can further include applying the body 105, 205 to the heated and/or pre-pressed barrier 115, 215, and then subjecting the body 105, 205 and the heated and/or pre-pressed barrier 115, 215 to a second heating and/or pressing process, thereby adhering or coupling the barrier 115, 215 to the body 105, 205. In at least one embodiment, any binder or adhesive present in the pre-pressed barrier 115, 215 can be at least partially cured such that the cured binder or adhesive does not contribute to the coupling of the barrier 115, 215 to the body 105, 205. Thus, the coupling of the barrier 115, 215 to the body 105, 205 can be provided by the heating and pressing the barrier/body, the presence of one or more adhesives mixed with the plurality of substrates forming the body 105, 205, and/or any uncured adhesive in the barrier 115, 215.

Alternatively, the body 105, 205 and the barrier 115, 215 of the sheathing assembly 100 can be coupled in a single process. In at least one embodiment, the single process may include locating the barrier 115, 215 on a support surface, applying the body 105, 205 to the barrier 115, 215, and then subjecting the body 105, 205 and the barrier 115, 215 to a single heating and/or pressing process. In at least one embodiment, the body 105, 205 and/or the barrier 115, 215 can be fabricated concurrently with the sheathing assembly 100, 200. For example, in at least one embodiment, the web or mixture of cellulosic material with the bicomponent fibers can be fed onto the forming surface and the body 105, 205 may be applied atop the web or mixture. The web and the body 105, 205 can then be subsequently heated and pressed to form the sheathing assembly 100, 200. Alternatively, the mixture of cellulosic material with the bicomponent fibers can be fed onto the forming surface to provide a first layer. A second layer including the substrates and/or resins that comprise the body layer 105 can then be provided atop the first layer. The resulting assembly of layers can then be subjected to a heating and pressing process sufficient to bond the layers of both the body 105, 205 and the barrier 115, 215 and couple the body 105, 205 to the barrier 115, 215 to thereby form the sheathing assembly 100.

In one or more embodiments, a roll of a material, e.g., an airlaid sheet made from a mixture of cellulose and polymer fibers, can be fed onto a forming line belt and a wood mat can be formed on top of the material as the forming line belt advances toward a press. The wood mat can be formed with the a first and second layer (206, 208) as surface or outer layers composed of lignocellulosic substrates oriented in a direction parallel with respect to one another and a third or core layer composed of lignocellulosic substrates oriented in a direction perpendicular to the first and second layers. The multi-layer structure can be formed into the desired dimensions and introduced to the press where pressure can be applied thereto to produce the sheathing assembly 205. Heat can also be applied to the multi-layer structure when pressed. The sheathing assembly 105 can be made in a similar manner.

about 0.5 kPa, about 1 kPa, about 2 kPa, about 3 kPa, or about 4 kPa to a high of about 3 kPa, about 4 kPa, about 4.5 kPa, about 5 kPa, or about 6 kPa. The airlaid material can be heated to a temperature from a low of about 200° C., about 250° C., about 300° C., about 350° C., about 375° C., about 400° C., or about 450° C., to a high of about 350° C., about 400° C., about 425° C., about 450° C., about 475° C., about 500° C., or about 550° C.

The temperature and pressure utilized during application of heat and/or pressure can vary depending on the application and properties desired for the sheathing assembly 100, 200. Further, the duration of the applied heat and/or pressure can also vary and can be dependent upon the press, the temperature of the press, the thickness of the sheathing assembly 100, 200, components of the body 105, 205 and/or the barrier 115, 215, as well as other factors. The body 105, 205 and the barrier 115, 215 can be contacted with one another and pressed to a pressure from a low of about 0.5 kPa, about 1 kPa, about 2 kPa, about 3 kPa, or about 4 kPa to a high of about 3 kPa, about 4 kPa, about 4.5 kPa, about 5 kPa, or about 6 kPa. For example, the body 105, 205 and the barrier 115, 215 can be contacted with one another and pressed to a pressure from about 0.5 kPa to about 6 kPa, from about 1 kPa to about 5 kPa, from about 2 kPa to about 4.5 kPa, or from about 3 kPa to about 4 kPa. The heating process can include subjecting the barrier 115, 215 to a temperature from a low of about 200° C., about 250° C., about 300° C., about 350° C., about 375° C., about 400° C., or about 450° C., to a high of about 350° C., about 400° C., about 425° C., about 450° C., about 475° C., about 500° C., or about 550° C. The temperature can also be from about 200 C.° to about 550 C°, from about 250 C.° to about 500 C°, from about 300 C.° to about 450 C°, or from about 350 C.° to about 425 C°.

In at least one embodiment, the heating and pressing process, in addition to other factors, can affect a peel strength between the barrier 115, 215 and the body 105, 205. In at least one embodiment, the peel strength between the barrier 115, 215 and the body 105, 205 in the sheathing assembly 100 without additional adhesive or “glue line” disposed therebetween can be equal to or greater than the prior art sheathing assemblies.

In one or more embodiments, the peel strength between the barrier 115, 215 and the body 105, 205 can be at least 0.0009 kgf/cm, at least 0.0015 kgf/cm, at least 0.003 kgf/cm, at least 0.015 kgf/cm, at least 0.03 kgf/cm, at least 0.045 kgf/cm, at least 0.06 kgf/cm, at least 0.09 kgf/cm, at least 0.15 kgf/cm, at least 0.18 kgf/cm, at least 0.21 kgf/cm, at least 0.24 kgf/cm, at least 0.27 kgf/cm, at least 0.3 kgf/cm, at least 0.6 kgf/cm, at least 0.9 kgf/cm, at least 1.2 kgf/cm, or at least 1.5 kgf/cm. In one or more embodiments, the peel strength can be from a low of about 0.0009 kgf/cm, about 0.0015 kgf/cm, or about 0.015 kgf/cm to a high of about 1.2 kgf/cm, about 1.5 kgf/cm, or about 2.0 kgf/cm. The peel strength can be determined using any standard test, such as the ASTM D6862 Standard Test Method for 90° Angle Resistance of Adhesives.

In one or more embodiments, the barrier 115, 215 can have an initial thickness of at least 0.01 mm, at least 0.025 mm, at least 0.05 mm, at least 0.1 mm, at least 0.15 mm, at least 0.2 mm, at least 0.25 mm, at least 0.3 mm, at least 0.35 mm, at least 0.4 mm, at least 0.45 mm, at least 0.5 mm, at least 0.55 mm, at least 0.6 mm, at least 0.65 mm, at least 0.7 mm, at least 0.75 mm, at least 0.8 mm, at least 0.85 mm, at least 0.9 mm, at least 0.95 mm, or at least 1 mm. In one or more embodiments, the thickness of the barrier 115, 215 can be less than 0.05 mm, less than 0.1 mm, less than 0.15 mm, less than 0.2 mm, less than 0.25 mm, less than 0.3 mm, less than 0.35 mm, less than 0.4 mm, less than 0.45 mm, less than 0.5 mm, less than 0.55 mm, less than 0.6 mm, less than 0.65 mm, less than 0.7 mm, less than 0.75 mm, less than 0.8 mm, less than 0.85 mm, less than 0.9 mm, less than 0.95 mm, or less than 1 mm. In one or more embodiments, the barrier 115, 215 can have an initial thickness from a low of about 0.05 mm, about 0.15 mm, or about 0.2 mm to a high of about 0.5 mm, about 0.8 mm, or about 1 mm. In one or more embodiments, the barrier 115, 215 can have an initial thickness ranging from a low of about 0.01 mm, about 0.05 mm, or about 0.1 mm to a high of about 0.2 mm, about 0.4 mm, or about 0.5 mm.

In one or more embodiments, the barrier 115, 215 when part of the sheathing assembly 100, 200 can have an final thickness of at least 0.01 mm, at least 0.025 mm, at least 0.05 mm, at least 0.1 mm, at least 0.15 mm, at least 0.2 mm, at least 0.25 mm, at least 0.3 mm, at least 0.35 mm, at least 0.4 mm, at least 0.45 mm, at least 0.5 mm, at least 0.55 mm, at least 0.6 mm, at least 0.65 mm, at least 0.7 mm, at least 0.75 mm, at least 0.8 mm, at least 0.85 mm, at least 0.9 mm, at least 0.95 mm, or at least 1 mm. In one or more embodiments, the thickness of the barrier 115, 215 when part of the sheathing can be from about 0.01 mm to about 1.5 mm, about 0.025 mm to about 1.2 mm, or about 0.05 mm to about 1.

In one or more embodiments, the body 105, 205 can have an initial thickness, i.e., prior to pressing and/or heating, from a low of about 2 mm, about 4 mm, about 6 mm, or about 8 mm to a high of about 20 mm, about 30 mm, about 35 mm, or about 40 mm. For example, the body 105, 205 can have an initial thickness of about 2 mm to about 40 mm, about 4 mm to about 35 mm, or about 6 mm to about 30 mm. In one or more embodiments, the body 105, 205 can have a final thickness, i.e., after heating and/or pressing, from a low of about 1 mm, about 2 mm, or about 4 mm to a high of about 15 mm, about 20 mm, or about 35 mm. For example, the thickness of the body 105, 205 when part of the sheathing 100, 200 can be from about 1 mm to about 35 mm, about 2 mm to about 20 mm, or about 4 mm to about 15 mm.

The barrier 115, 215 can have a coefficient of friction equal to or better than plywood or oriented strand board when dry and/or wet. The barrier 115, 215 can have a dry coefficient of friction (p) from a low of about 0.1μ, about 0.5μ, about 1.0μ, about 1.5μ, to a high of about 1.5μ, about 2.0μ, about 2.2μ, about 2.5μ, as measured according to ASTM F1679-04. For example, the barrier 115, 215 can have a dry coefficient of friction from about 0.5μ to about 2.5μ, about 1.0μ to about 2.2μ, or about 1.0μ to about 1.5μ, as measured according to ASTM F1679-04. The barrier 115, 215 can have a wet coefficient of friction from a low of about 0.1μ, about 0.5μ, about 1.0μ, about 1.5μ, to a high of about 1.5μ, about 2.0μ, about 2.2μ, about 2.5μ, as measured according to ASTM C1028-07e1. For example, the barrier 115, 215 can have a wet coefficient of friction from about 0.5μ to about 2.5μ, about 1.0μ to about 2.2μ, or about 1.0μ to about 1.5μ, as measured according to ASTM C1028-07e1.

In one or more embodiments, one or more coatings can be applied to the barrier 115, 215 to increase or improve the coefficient of friction, wet and/or dry, thereof. For example, the barrier 115, 215 can include an anti-skid coating to reduce the likelihood of a person slipping should the sheathing assembly 100, 200 be used as roof decking, for example. The surface of the barrier 115, 215 can also be textured or otherwise configured to increase or improve the coefficient of friction, wet and/or dry, thereof. For example, the skid resistant surface can include one or more patterns made by embossing, debossing, scoring, or any other method that alters the texture of the barrier 115, 215. The skid resistant surface can include a plurality of protrusions extending from the barrier 115, 215. The skid resistant surface can include a plurality of depressions formed in the barrier 115, 215 such that the depressions provide a suction effect when walked on. In at least one embodiment, the textured surface can be provided without the addition of grit or the like to the surface.

In at least one embodiment, the outer surface of the barrier 115, 215, i.e., the surface opposed to the surface in contact with the body 105, 205, can be textured during formation of the sheathing assembly 100. For example, the barrier 115, 215 can be located onto a forming surface or wire screen, and the lignocellulose substrates and adhesive mixture (“resinated furnish”) can be deposited onto the barrier 115, 215 to form a pre-assembly of the barrier and the body. The pre-assembly can be heated and pressed, with sufficient heat and pressure applied thereto to secure the layers of the sheathing assembly 100, 200 and to form the textured surface via the wire screen.

Although not shown in FIGS. 1 and 2, the sheathing assembly 100 can further include an edge seal or edge coating disposed thereabout. The edge coating can reduce or prevent water and/or air from penetrating into the edges sides of the sheathing assembly 100. The edge coating can include one or more paints, pastes, lacquers, laminates, waxes, gels, glues, epoxies, tapes, polymeric materials, resins or any combination thereof.

In one or more embodiments, any of the layers 105, 115, or portions thereof can include one or more additives. As used herein, the term “additive” can include, but is not limited to, one or more opacifying agents, pigments, colorants, cavitating agents, slip agents, antioxidants, anti-fog agents, anti-static agents, fillers, moisture barrier additives, gas barrier additives, fire retardant additives, antimicrobial additives, chemical resistant additives, mold resistant agents, termite resistant agents, UV protective additives, and combinations thereof. Such additives can be used in effective amounts, which vary depending upon the property required.

In one or more embodiments, one or more sheathing assemblies 100, 200 can be disposed on a frame or other support member to provide a supported sheathing assembly 100, 200. The frame can be or include, but is not limited to, a wood frame, metal frame, concrete or cement frame, cinder block frame, or any combination thereof. The frame can be configured to provide an enclosed structure such as a house, garage, trailer, or other residential structure. The frame can be configured to provide an enclosed structure such as a commercial building, warehouse, storage building, or any other commercial structure. The sheathing assembly 100, 200 can be disposed about a portion of the frame or the entire frame to provide an enclosed structure. The sheathing assembly 100, 200 can be disposed about the frame with the barrier 115, 215 oriented toward the outside, i.e., away from the frame. In other words, the body 105, 205 of the sheathing assembly 100, 200 can be oriented toward and/or can at least partially contact the frame. The sheathing assembly 100, 200 can provide or otherwise make up a portion of a building structure's wall, roof, and/or floor. In one or more embodiments, a plurality of sheathing assemblies 100, 200 can be disposed on the frame such that each sheathing assembly 100, 200 is spaced apart. For example, a gap of about 1 mm, about 2 mm, about 3 mm, about 4 mm, or about 5 mm or more can be provided between adjacent sheathing assemblies 100. In one or more embodiments, tape can be disposed along each seam or gap between the one or more sheathing assemblies 100, 200. The tape can provide a water and/or air resistant seal. Illustrative tapes can include, but are not limited to, building code compliant tapes, such as those sold by the Pactiv Corporation and/or the Georgia Pacific Corporation.

Although not shown, two sheathing assemblies 100, 200 can be joined together at any suitable angle with respect to one another. For example, sheathing assemblies 100 can be joined or positioned together at an angle ranging from 0° (linearly joined end to end) to 180° (stacked on top of one another. In one or more embodiments, the joint provided between the sheathing assemblies 100 can be located at any location about a structure, for example a corner, a roof seam or joint, a floor seam or joint, a wall seam or joint, and the like.

In any of the embodiments described herein, the sheathing assembly 100 can include one or more radiant barriers disposed thereon. The radiant barrier can be disposed on a side of the body 105 opposite the barrier 115, 215. The radiant barrier can be disposed on the barrier 115, 215. The radiant barrier can be disposed between the barrier 115, 215 and the body 105, 205. The radiant barrier material can be or include a reflective surface that reflects infrared radiation that penetrates through the sheathing assembly 100. The radiant barrier can be or include one or more layers of a radiant barrier sheet, such as metal foil, for example aluminum foil, a polymer sheet, such as a polyester sheet. The radiant barrier can be affixed to the body 105, 205 of the sheathing assembly 100 using one or more adhesives. The radiant barrier can be or include one or more layers of a sprayed on coating that reduces the transfer of radiant energy therethrough. Illustrative commercially available spray on radiant barriers can include a water-based paint called HeatBloc-75 available from STS Coatings and/or Radiance® available from BASF®. Additionally, the radiant barrier can provide protection against ultraviolet light per ASTM G53, G154, which does not delaminate, reduce slip resistance, or promote fading.

Embodiments described herein having the shape or form of a panel, layer, sheet, board, or the like can be in the form of a rectangular prism that includes six outer surfaces, i.e., three pairs of oppositely facing surfaces. The first pair of oppositely facing surfaces of the composite product can include a first or “top” surface and an opposing second or “bottom” surface. The second and third pairs of oppositely facing surfaces of the composite product can be referred to as the “side surfaces” that have a surface area less than the surface area of the first and second surfaces. As such, embodiments described herein having the shape or form of a panel, sheet, board, or the like can have an average thickness, where the average thickness is the length or distance between the first and second surfaces.

### EXAMPLES

In order to provide a better understanding of the foregoing discussion, the following non-limiting examples are offered. Although the examples may be directed to specific embodiments, they are not to be viewed as limiting the invention in any specific respect. All parts, proportions, and percentages are by weight unless otherwise indicated.

A series of water absorption and permeability tests were performed on different barriers, namely examples 1, 2, and 3 (tabulated in Tables 1, 2, and 3, respectively). For all examples, pulp fibers and bicomponent fibers were combined to provide a composite barrier 115, 215. In the series of examples, the ratio of the pulp fibers and synthetic material, or bicomponent fibers, were varied to observe the effects of the hydrophobic synthetic material with the hydrophilic pulp fiber. The bicomponent fibers in all samples included a polyethylene (PE) sheath and a polypropylene (PP) core. The barriers 115, 215 were tested after coupling to the body 105, 205 through one or more heating and pressing processes. Coupling of the barrier 115, 215 to the body 105, 205 was accomplished by either (1) pre-pressing the barrier 115, 215 and then subsequently pressing the pre-pressed barrier 115, 215 to the body 105, 205; or (2) the barrier 115, 215 was pressed and coupled to the body 105, 205 in a single step. In all the examples, the coupling of the body 105, 205 to the barrier 115, 215 was accomplished with no additional binder or resin applied therebetween.

The body 105, 205 was a wood derived panel having a combination of 60% total surface layer and 40% core layer, based on thickness. Each panel had two outer or surface layers that were bonded to opposing sides of a core layer, thus having three total layers. The lignocellulose substrates used to produce all panels was Southern Yellow Pine having an average flake size of about 3 inches and having a moisture concentration of about 6 wt % to about 7 wt %.

Preparation of the panels used one of four resins or binder compositions to bind the substrates of the surface layers of each panel and the core layers of each panel. The PF resin used to bind the substrates of the outer layers for all examples had the following properties: 45.0 wt % solids, pH of 9.9, a viscosity of about 200 cP, an alkalinity of about 2.5%, and a molar ratio of formaldehyde to phenol (F:P) of about 2.5:1. The total amount of resin or binder composition combined with the substrates of the surface layers was about 3.5 wt %, based on the dry weight of the substrates. Also added to the mixture of substrates and resin or binder composition was slack wax in an amount of about 1 wt %, based on the dry weight of the substrates.

The press used to form the panels was a Wabash Metals Hydraulic Press having press platens of 24 inches×24 inches. The press heated the panels to a temperature of about 210° C. +/−5.5° C. when the panels were pressed. A press time with the minimum press time giving approximately a 40 psi internal bond strength (IB). The formed panels or body 105, 205 were about 0.75 inches thick'18 inches×18 inches at 43 pounds per cubic foot (pcf). As such, the outer or surface layers were about 0.225 inches thick and the core layer was about 0.3 inches thick.

A 1″ Cobb Ring test was used to test for absorption and permeability. A cylinder was secured to the barrier of the sheathing assembly with a hot melt adhesive to provide a seal between the ring and the barrier to prevent water from leaking through the interface. Water was then introduced into the cylinder and the time required for the water to penetrate through the barrier was recorded.

In addition to testing the water absorption and penetration, the integrity and adherence of the barrier 115, 215 to the heated press platen during the pressing process was also investigated. For all examples, a barrier 115, 215 having three distinct layers (Layer 1, 2, and 3, respectively) were tested. Before coupling process, the barrier 115, 215 was placed atop the body such that Layer 1 would be directly subjected to the heated press platen and Layer 3 would be in direct contact with the body 105, 205. To test the integrity and adherence of the barrier as the barrier was pressed, the ratio of the pulp fibers and bicomponent fibers was varied in each respective layer. A pre-pressed barrier was also investigated to test the integrity and adherence of the barrier. The results of the tests for each sample are shown in the following Tables:

### Example 1

TABLE 1
70/30 Sample

| | Weight % | Description |
|---|---|---|
| Pulp | 70 | Untreated Pulp |
| Bicomponent Fiber | 30 | Sheath: PE; Core: PP |

| | |
|---|---|
| Layers | Distribution (Weight %) |

| | | |
|---|---|---|
| Layer 1 (Wire Side) | 15.70 | 18.00 |
| Layer 2 | 27.20 | 6.00 |
| Layer 3 (Body Side) | 27.10 | 6.00 |
| Total | 70 | 30.00 |

| | |
|---|---|
| Water Time | 2.5 h |

In example 1, a barrier was provided by an airlaid sheet with three layers (Layer 1, 2, 3), wherein each of the layers included varying concentrations of pulp fibers and bicomponent fibers indicated in Table 1. The airlaid had an overall concentration of 70 wt % pulp fibers and 30 wt % bicomponent fibers. The airlaid was positioned atop an OSB panel and subjected to heat and pressure, wherein Layer 1 (wire side) was in direct contact with the press platen. The integrity of the barrier after the heating and pressing process was observed visually and showed residual bicomponent polymer fibers adhering to the press platen. The adhesion of the bicomponent polymer fibers also result in tearing of the airlaid after the heating and pressing process.

TABLE 2
60/40 Sample

| | Weight % | Description |
|---|---|---|
| Pulp | 60 | Untreated Pulp |
| Bicomponent Fiber | 40 | Sheath: PE; Core: PP |

Distribution (Weight %)

| | | |
|---|---|---|
| Layer 1 (Wire Side) | 13.50 | 24.00 |
| Layer 2 | 23.30 | 8.00 |
| Layer 3 (Body Side) | 23.20 | 8.00 |
| Total | 60.00 | 40.00 |

| | |
|---|---|
| Water Time | 3.5 h |

### Example 2

In example 2, a barrier was provided by an airlaid sheet with three layers (Layer 1, 2, 3), wherein each of the layers included varying concentrations of pulp fibers and bicomponent fibers, indicated in Table 2. The airlaid had an overall concentration of 60 wt % pulp fibers and 40 wt % bicomponent fibers. The airlaid was positioned atop an OSB panel and subjected to heat and pressure, wherein Layer 1 (wire side) was in direct contact with the press platen. The integrity of the barrier after the heating and pressing process was observed visually and showed residual bicomponent polymer fibers adhering to the press platen. The adhesion of the bicomponent polymer fibers also result in tearing of the airlaid after the heating and pressing process.

TABLE 3
60/40 Sample (Pre-Pressed)

| | Weight % | Description |
|---|---|---|
| Pulp | 60 | Untreated Pulp |
| Bicomponent Fiber | 40 | Sheath: PE; Core: PP |

Distribution (Weight %)

| | | |
|---|---|---|
| Layer 1 (Wire Side) | 13.50 | 24.00 |
| Layer 2 | 23.30 | 8.00 |
| Layer 3 (Body Side) | 23.20 | 8.00 |
| Total | 60.00 | 40.00 |

| | |
|---|---|
| Water Time | 8 h |

### Example 3

In example 3, a barrier was provided by an airlaid sheet with three layers (Layer 1, 2, 3), wherein each of the layers included varying concentrations of pulp fibers and bicomponent fibers, indicated in Table 3. The airlaid had an overall concentration of 60 wt % pulp fibers and 40 wt % bicomponent fibers. The airlaid was subjected to a first heating and pressing, where Layer 1 (wire side) was in direct contact with the press platen to pre-press the airlaid sheet. The pre-pressed airlaid sheet was then subsequently placed atop an OSB panel and subjected to a second heating and pressing process, wherein Layer 1 (wire side) was in direct contact with the press platen to pre-press the airlaid sheet. The integrity of the barrier after the heating and pressing process was observed visually and showed no signs of residual bicomponent polymer fibers adhering to the press platen. Further, no tearing of the pre-pressed airlaid barrier was observed.

As shown in Tables 1-3, increasing the ratio of the bicomponent fibers to the pulp fibers in the barrier resulted in a decrease in permeability of water therethrough. As shown in Tables 2 and 3, pre-pressing the barrier before coupling the barrier to the body significantly decreased the permeability of water therethrough. It was also observed that pre-pressing the barrier prior to coupling with the body did not completely deactivate the ability of the barrier to further couple with the body, as sufficient coupling between the barrier and the body was observed.

Reducing the ratio of the bicomponent fibers to the pulp fibers in the outermost layer, Layer 1, reduced the adhesion between the barrier and the heated roller. By reducing the adhesion of the barrier to the heated roller during the coupling process, the tearing of the barrier was eliminated.

Embodiments of the present disclosure further relate to any one or more of the following paragraphs:

1. A sheathing assembly, comprising: a body comprising a plurality of substrates and an at least partially cured first adhesive, wherein a concentration of the first adhesive is substantially constant throughout the body; and a barrier secured to a first side of the body and optionally comprising an at least partially cured second adhesive, wherein, if the second adhesive is present, a concentration of the second adhesive is substantially constant throughout the barrier, and wherein any adhesive between the body and the barrier consists of either the first adhesive, the second adhesive, or a combination of the first and second adhesive.

2. The sheathing assembly of paragraph 1, wherein the sheathing assembly is free from any adhesive between the body and the barrier except for the first and, if present, the second adhesive.

3. The sheathing assembly of paragraph 1 or 2, wherein the sheathing comprises only the first adhesive and, if present, the optional second adhesive.

4. The sheathing assembly according to any one of paragraphs 1 to 3, wherein the first and second adhesives are different from one another.

5. The sheathing assembly according to any one of paragraphs 1 to 4, wherein the barrier comprises a mixture of cellulosic fibers and polymer fibers.

6. The sheathing assembly according to any one of paragraphs 5, wherein the barrier layer comprises a mixture of about 5 wt % to about 95 wt % cellulosic fibers and about 5 wt % to about 95 wt % polymer fibers.

7. The sheathing assembly of paragraph 6, wherein the polymer fibers are bicomponent fibers having an inner core comprising a first polymer and an outer layer comprising a second polymer, wherein the first and second polymers are different.

8. The sheathing assembly according to any one of paragraphs 1 to 7, wherein the body comprises wood, engineered wood, or a combination thereof.

9. The sheathing assembly of paragraph 8, wherein the body comprises oriented strand board.

10. The sheathing assembly according to any one of paragraphs 1 to 9, wherein the barrier comprises a cross-woven polyolefin wrap that provides a water and air resistant barrier.

11. The sheathing assembly according to any one of paragraphs 1 to 10, wherein the barrier comprises a plurality of cellulosic fibers and a plurality of polymer fibers.

12. The sheathing assembly according to any one of paragraphs 1 to 11, wherein the barrier comprises one or more layers, and wherein each layer comprises a plurality of cellulosic fibers and a plurality of polymer fibers.

13. The sheathing assembly according to any one of paragraphs 1 to 12, wherein the barrier layer comprises at least a first layer and a second layer, and wherein each layer comprises a plurality of cellulosic fibers, a plurality of polymer fibers, or a mixture of cellulosic fibers and polymer fibers.

14. The sheathing assembly of paragraph 13, wherein the first and second layers comprise a different ratio of cellulosic fibers and polymer fibers with respect to one another.

15. The sheathing assembly according to any one of paragraphs 1 to 12, wherein the barrier comprises at least two layers, wherein the first layer of the barrier is in direct contact with the body and comprises about 5 wt % to about 95 wt % cellulosic fibers and about 5 wt % to about 95 wt % polymer fibers, and wherein the second layer of the barrier comprises about 5 wt % to about 95 wt % cellulosic fibers and about 5 wt % to about 95 wt % polymer fibers.

16. The sheathing assembly according to any one of paragraphs 1 to 12, wherein the barrier comprises at least three layers, wherein the first layer of the barrier is in direct contact with the body and comprises about 5 wt % to about 95 wt % cellulosic fiber and about 5 wt % to about 95 wt % polymer fiber, wherein the second layer of the barrier is located between the first and third layers and comprises about 5 wt % to about 95 wt % cellulosic fiber and about 5 wt % to about 95 wt % polymer fiber, and wherein the third layer of the barrier comprises about 5 wt % to about 95 wt % cellulosic fiber and about 5 wt % to about 95 wt % polymer fiber.

17. The sheathing assembly according to any one of paragraphs 1 to 12, wherein the barrier comprises a mixture of cellulosic fibers and polymer fibers, and wherein the polymer fibers comprise an olefinic copolymer.

18. The sheathing assembly according to any one of paragraphs 1 to 12, wherein the barrier comprises a mixture of cellulosic fibers and polymer fibers, wherein the polymer fibers comprises polyethylene, polypropylene, polyester, butylene polymer, ethylene polymer, high density polyethylene, medium density polyethylene, low density polyethylene, propylene, isotactic polypropylene, high crystallinity polypropylene, ethylene-propylene, ethylene-propylene-butylene terpolymers, propylene-butylene copolymer, an ethylene elastomer, a ethylene-based plastomer, or any combination thereof.

19. The sheathing assembly according to any one of paragraphs 1 to 12, wherein the barrier comprises a mixture of cellulosic fibers and polymer fibers, and wherein the cellulosic fibers comprise cellulosic nitrate, cellulosic acetate, cellulosic acetate butyrate, ethyl cellulose, or any combination thereof.

20. The sheathing assembly according to any one of paragraphs 1 to 12, wherein the barrier comprises a mixture of cellulosic fibers and polymer fibers, and wherein the cellulosic fibers comprise pulp fibers.

21. The sheathing assembly according to any one of paragraphs 1 to 12, wherein the barrier comprises a mixture of cellulosic fibers and polymer fibers, and wherein the polymer fibers comprise bicomponent fibers.

22. The sheathing assembly of paragraph 21, wherein the bicomponent fibers comprise a sheath and a core, and wherein the sheath comprises a first polymer and the core comprises a second polymer, wherein the first and second polymers are different.

23. The sheathing assembly of paragraph 22, wherein the sheath further comprises a melt additive.

24. The sheathing assembly of paragraph 23, wherein a melting point of the first polymer is less than a melting point of the second polymer.

25. The sheathing assembly according to any one of paragraphs 1 to 24, wherein the barrier comprises a textured surface.

26. The sheathing assembly according to any one of paragraphs 1 to 25, wherein the barrier has a water vapor transmission rate of about 0.6 g/m²/24 hrs, as measured according to ASTM E96 procedure A.

27. The sheathing assembly according to any one of paragraphs 1 to 26, wherein the barrier has a water vapor transmission rate of about 0.4 g/m²/24 hrs, as measured according to ASTM E96 procedure A.

28. The sheathing assembly according to any one of paragraphs 1 to 27, wherein the barrier has a liquid water transmission rate of about 0.1 g/m²/24 hrs, as measured via a Cobb ring according to ASTM D5795.

29. The sheathing assembly according to any one of paragraphs 1 to 28, wherein the barrier has a coefficient of friction of about 1.0μ.

30. The sheathing assembly according to any one of paragraphs 1 to 29, wherein the at least partially cured second adhesive is present and comprises a cured thermoplastic material.

31. The sheathing assembly according to any one of paragraphs 1 to 30, wherein the at least partially cured second adhesive is present and comprises thermally bonded polymer fibers.

32. A sheathing assembly, comprising: a body comprising at least a first layer and a second layer, wherein the first layer comprises a mixture of an at least partially cured first adhesive and a first plurality of substrates, wherein the second layer comprises a mixture of an at least partially cured second adhesive and a second plurality of substrates, wherein a concentration of the first adhesive is substantially constant throughout the first layer; and a barrier secured to a first side of the first layer of the body and optionally comprising an at least partially cured third adhesive, wherein, if the third adhesive is present, a concentration of the third adhesive is substantially constant throughout the barrier, and wherein any adhesive between the first layer of the body and the barrier consists of either the first adhesive, the third adhesive, or a combination of the first and third adhesive.

33. A sheathing assembly, comprising: a barrier comprising at least a first layer and a second layer, wherein the first layer comprises a mixture of an at least partially cured first adhesive and a first plurality of substrates, wherein the second layer comprises a mixture of an at least partially cured second adhesive and a second plurality of substrates, wherein a concentration of the first adhesive is substantially constant throughout the first layer; and a body secured to a first side of the first layer of the barrier and optionally comprising an at least partially cured third adhesive, wherein, if the third adhesive is present, a concentration of the third adhesive is substantially constant throughout the body, and wherein any adhesive between the first layer of the barrier and the body consists of either the first adhesive, the third adhesive, or a combination of the first and third adhesive.

34. A method for making a sheathing assembly, comprising: placing a barrier into direct contact with a body; and subjecting the barrier and the body to conditions sufficient to at least partially secure the barrier layer to the body to form a sheathing assembly, wherein the body comprises a mixture of a first adhesive and a first plurality of substrates, and wherein any adhesive present at the interface between the barrier and the body consists of the first adhesive and any second adhesive optionally present in the barrier as a component of a mixture of the second adhesive and a second plurality of substrates.

35. A method for making a sheathing assembly, comprising: locating a barrier and a body proximate one another; and pressing the barrier and the body together to at least partially secure the barrier layer to the body to form a sheathing assembly, wherein the body comprises a mixture of an adhesive and a plurality of substrates, and wherein no second adhesive is disposed between the barrier and the body.

36. A method for making a sheathing assembly, comprising: locating a barrier and a body proximate one another; and pressing the barrier and the body together to at least partially secure the barrier layer to the body to form a sheathing assembly, wherein the body comprises a mixture of a first adhesive and a first plurality of substrates, wherein the barrier comprises a second plurality of substrates and optionally a second adhesive, and wherein any adhesive between the body and the barrier consists of either the first adhesive, the second adhesive, or a combination of the first and second adhesive.

37. A method for making a sheathing assembly, comprising: depositing a barrier onto a support surface; depositing a resinated furnish onto the barrier to form a multi-layer structure, wherein the resinated furnish comprises a plurality of lignocellulosic substrates and one or more first adhesives; pressing and heating the multi-layer structure to produce a sheathing assembly, where any adhesive present at the interface between the barrier and the resinated furnish consists of the first adhesive, a second adhesive optionally present in the barrier as a component of a mixture of the second adhesive, cellulosic fibers, and polymer fibers.

38. A non-woven sheet, comprising: a mixture of cellulosic fibers and polymer fibers, wherein the cellulosic fibers are present in an amount of about 5 wt % to about 95 wt %, based on the combined weight of the cellulosic fibers and the polymer fibers.

39. The non-woven sheet of paragraph 38, wherein the polymer fibers comprise bicomponent polymer fibers.

40. The non-woven sheet of paragraph 38 or 39, wherein the non-woven sheet has a thickness of about 0.1 mm to about 1.0 mm.

41. The non-woven sheet according to any one of paragraphs 38 to 40, wherein the non-woven sheet has a liquid water transmission rate of less than about 0.5 g/m²/24 hrs, according to ASTM E96 procedure A.

42. The non-woven sheet according to any one of paragraphs 38 to 41, wherein the cellulosic fibers are present in an amount of about 20 wt % to about 70 wt %, based on the combined weight of the cellulosic fibers and the polymer fibers.

43. A building structure, comprising: a framed structure; one or more sheathing assemblies disposed on an exterior side of the framed structure, wherein the one or more sheathing assemblies comprises: a body comprising a plurality of substrates and an at least partially cured first adhesive, wherein a concentration of the first adhesive is substantially constant throughout the body; and a barrier secured to a first side of the body and optionally comprising an at least partially cured second adhesive, wherein, if the second adhesive is present, a concentration of the second adhesive is substantially constant throughout the barrier, and wherein any adhesive between the body and the barrier consists of either the first adhesive, the second adhesive, or a combination of the first and second adhesive.

44. A sheathing assembly, comprising: a body comprising a plurality of substrates and a first adhesive; and a barrier secured to a first side of the body and optionally comprising an at least partially cured second adhesive, and wherein any adhesive between the body and the barrier consists of either the first adhesive, the second adhesive, or a combination of the first and second adhesive.

45. A sheathing assembly, comprising: a body comprising at least a first layer and a second layer, wherein the first layer comprises a mixture of an at least partially cured first adhesive and a first plurality of substrates, wherein the second layer comprises a mixture of an at least partially cured second adhesive and a second plurality of substrates, and wherein a concentration of the first adhesive is substantially constant throughout the first layer; and a barrier secured to a first side of the first layer of the body and optionally comprising an at least partially cured third adhesive, wherein any adhesive between the first layer of the body and the barrier consists of either the first adhesive, the third adhesive, or a combination of the first and third adhesive.

46. A sheathing assembly, comprising: a body comprising a plurality of lignocellulosic substrates; and a barrier secured to a first side of the body, wherein any adhesive disposed between the body and the barrier consists of: (1) a first adhesive disposed throughout the body and having a substantially constant concentration within the body, (2) a second adhesive disposed throughout the barrier and having a substantially constant concentration within the barrier, or (3) a first adhesive disposed throughout the body and having a substantially constant concentration within the body and a second adhesive disposed throughout the barrier and having a substantially constant concentration within the barrier.

47. The sheathing assembly according to paragraph 46, wherein a peel strength between the barrier and the body is at least 0.0009 kgf/cm to about 2 kgf/cm, as measured according to ASTM D6862.

48. The sheathing assembly according to paragraph 46 or 47, wherein the sheathing assembly is free from any mechanical fastener securing the barrier to the first side of the body.

49. The sheathing assembly according to any one of paragraphs 46 to 48, wherein the body comprises the first adhesive, and wherein the concentration of the first adhesive within the body varies by less than 5%.

50. The sheathing assembly according to any one of paragraphs 46 to 49, wherein the barrier comprises the second adhesive, and wherein the concentration of the second adhesive within the barrier varies by less than 5%.

51. The sheathing assembly according to any one of paragraphs 46 to 50, wherein the first adhesive and the second adhesive are different from one another.

52. The sheathing assembly according to any one of paragraphs 46 to 51, wherein the barrier comprises a mixture of about 5 wt % to about 95 wt % cellulosic fibers and about 5 wt % to about 95 wt % polymer fibers.

53. The sheathing assembly according to paragraph 52, wherein the polymer fibers are bicomponent fibers having an inner core comprising a first polymer and an outer layer comprising a second polymer, and wherein the first polymer and the second polymer are different from one another.

54. The sheathing assembly according to any one of paragraphs 46 to 53, wherein the body is particleboard, medium density fiberboard, high density fiberboard, waferboard, or oriented strand board.

55. The sheathing assembly according to any one of paragraphs 46 to 54, wherein the barrier comprises a cross-woven polyolefin wrap that provides a water and air resistant barrier.

56. The sheathing assembly according to any one of paragraphs 46 to 55, wherein the barrier comprises a mixture of cellulosic fibers and polymer fibers, wherein the polymer fibers comprise bicomponent fibers, wherein the bicomponent fibers comprise a sheath and a core, wherein the sheath comprises a first polymer and a melt additive, wherein the core comprises a second polymer, wherein the first and second polymers are different, and wherein a melting point of the first polymer is less than a melting point of the second polymer.

57. The sheathing assembly according to any one of paragraphs 46 to 56, wherein the barrier has a water vapor transmission rate of about 0.1 g/m²/24 hrs to about 9.0 g/m²/24 hrs as measured according to ASTM E96 procedure A, wherein the barrier has a dry coefficient of friction of about 0.5μ to about 2.5μ, as measured according to ASTM F1679-04, and wherein the barrier has a wet coefficient of friction from about 0.5μ to about 2.5∞ as measured according to ASTM C1028-07e1.

58. The sheathing assembly according to any one of paragraphs 46 to 57, wherein the barrier comprises a non-woven sheet comprising a mixture of cellulosic fibers and polymer fibers, wherein the cellulosic fibers are present in an amount of about 5 wt % to about 95 wt %, based on the combined weight of the cellulosic fibers and the polymer fibers.

59. A sheathing assembly, comprising: a body comprising a plurality of lignocellulosic substrates and an adhesive, wherein a concentration of the adhesive is substantially constant throughout the body; and a barrier comprising a mixture of cellulosic fibers and polymer fibers secured to a first side of the body, wherein the cellulosic fibers are present in an amount of about 5 wt % to about 95 wt %, based on the combined weight of the cellulosic fibers and the polymer fibers, wherein the polymer fibers comprise bicomponent polymer fibers, wherein any adhesive disposed between the body and the barrier consists of: (1) the first adhesive, (2) a second adhesive disposed throughout the barrier and having a substantially constant concentration within the barrier, or (3) the first adhesive and a second adhesive disposed throughout the barrier and having a substantially constant concentration within the barrier, and wherein a peel strength between the barrier and the body is at least 0.0009 kgf/cm to about 2 kgf/cm, as measured according to ASTM D6862.

60. The sheathing assembly according to paragraph 59, wherein the body is particleboard, medium density fiberboard, high density fiberboard, waferboard, or oriented strand board, wherein the adhesive comprises an isocyanate resin, an aldehyde based resin, an oxidative binder, or any mixture thereof, wherein the bicomponent fibers comprise a sheath and a core, wherein the sheath comprises a first polymer and a melt additive, wherein the core comprises a second polymer, wherein the first and second polymers are different, and wherein a melting point of the first polymer is less than a melting point of the second polymer.

61. The sheathing assembly according to paragraph 59 or 60, wherein the non-woven sheet has a thickness of about 0.1 mm to about 1.0 mm, wherein the barrier has a water vapor transmission rate of about 0.1 g/m²/24 hrs to about 9.0 g/m²/24 hrs as measured according to ASTM E96 procedure A, wherein the barrier has a dry coefficient of friction of about 0.5μ to about 2.5μ, as measured according to ASTM F 1679-04, and wherein the barrier has a wet coefficient of friction from about 0.5∞ to about 2.5μ as measured according to ASTM C1028-07e1.

62. The sheathing assembly according to any one of paragraphs 46 to 61, wherein the body comprises the first adhesive disposed throughout, and wherein the first adhesive is disposed between the body and the barrier.

63. The sheathing assembly according to anyone of paragraphs 46 to 62, wherein the barrier comprises the second adhesive disposed throughout, and wherein the second adhesive is disposed between the body and the barrier.

64. The sheathing assembly according to any one of paragraphs 46 to 63, wherein the body comprises the first adhesive disposed throughout, wherein the barrier comprises the second adhesive disposed throughout, and wherein both the first adhesive and the second adhesive are disposed between the body and the barrier.

65. A method for making a sheathing assembly, comprising: locating a barrier and a body proximate one another, wherein the body comprises a plurality of lignocellulosic substrates; and pressing the barrier and the body together to at least partially secure the barrier to the body to form a sheathing assembly, wherein any adhesive disposed between the body and the barrier consists of: (1) a first adhesive disposed throughout the body and having a substantially constant concentration within the body, (2) a second adhesive disposed throughout the barrier and having a substantially constant concentration within the barrier, or (3) a first adhesive disposed throughout the body and having a substantially constant concentration within the body and a second adhesive disposed throughout the barrier and having a substantially constant concentration within the barrier.

66. The method according to paragraph 65, wherein a peel strength between the barrier and the body is at least 0.0009 kgf/cm to about 2 kgf/cm, as measured according to ASTM D6862.

67. The method according to paragraph 65 or 66, wherein the body comprises the first adhesive, and wherein the concentration of the first adhesive within the body varies by less than 5%.

68. The method according to any one of paragraphs 65 to 67, wherein the barrier comprises a mixture of about 5 wt % to about 95 wt % cellulosic fibers and about 5 wt % to about 95 wt % polymer fibers wherein the polymer fibers are bicomponent fibers having an inner core comprising a first polymer and an outer layer comprising a second polymer, and wherein the first polymer and the second polymer are different from one another.

69. The method according to any one of paragraphs 65 to 68, wherein the sheathing assembly is free from any mechanical fastener securing the barrier to the first side of the body.

70. The method according to any one of paragraphs 65 to 69, wherein the body comprises the first adhesive, and wherein the concentration of the first adhesive within the body varies by less than 5%.

71. The method according to any one of paragraphs 65 to 70, wherein the barrier comprises the second adhesive, and wherein the concentration of the second adhesive within the barrier varies by less than 5%.

72. The method according to any one of paragraphs 65 to 71, wherein the first adhesive and the second adhesive are different from one another.

73. The method according to any one of paragraphs 65 to 72, wherein the barrier comprises a mixture of about 5 wt % to about 95 wt % cellulosic fibers and about 5 wt % to about 95 wt % polymer fibers.

74. The method according to paragraph 73, wherein the polymer fibers are bicomponent fibers having an inner core comprising a first polymer and an outer layer comprising a second polymer, and wherein the first polymer and the second polymer are different from one another.

75. The method according to any one of paragraphs 65 to 74, wherein the body is particleboard, medium density fiberboard, high density fiberboard, waferboard, or oriented strand board.

76. The method according to any one of paragraphs 65 to 75, wherein the barrier comprises a cross-woven polyolefin wrap that provides a water and air resistant barrier.

77. The method according to any one of paragraphs 65 to 76, wherein the barrier comprises a mixture of cellulosic fibers and polymer fibers, wherein the polymer fibers comprise bicomponent fibers, wherein the bicomponent fibers comprise a sheath and a core, wherein the sheath comprises a first polymer and a melt additive, wherein the core comprises a second polymer, wherein the first and second polymers are different, and wherein a melting point of the first polymer is less than a melting point of the second polymer.

78. The method according to any one of paragraphs 65 to 77, wherein the barrier has a water vapor transmission rate of about 0.1 g/m²/24 hrs to about 9.0 g/m²/24 hrs as measured according to ASTM E96 procedure A, wherein the barrier has a dry coefficient of friction of about 0.5μ to about 2.5μ, as measured according to ASTM F1679-04, and wherein the barrier has a wet coefficient of friction from about 0.5∞ to about 2.5μ as measured according to ASTM C1028-07e1.

79. The method according to any one of paragraphs 65 to 78, wherein the barrier comprises a non-woven sheet comprising a mixture of cellulosic fibers and polymer fibers, wherein the cellulosic fibers are present in an amount of about 5 wt % to about 95 wt %, based on the combined weight of the cellulosic fibers and the polymer fibers.

80. The method according to any one of paragraphs 65 to 79, wherein the body comprises the first adhesive disposed throughout, and wherein the first adhesive is disposed between the body and the barrier.

81. The method according to anyone of paragraphs 65 to 80, wherein the barrier comprises the second adhesive disposed throughout, and wherein the second adhesive is disposed between the body and the barrier.

82. The method according to any one of paragraphs 65 to 81, wherein the body comprises the first adhesive disposed throughout, wherein the barrier comprises the second adhesive disposed throughout, and wherein both the first adhesive and the second adhesive are disposed between the body and the barrier.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. A sheathing assembly, comprising:
a body comprising a plurality of lignocellulosic substrates; and
a barrier secured to a first side of the body, wherein any adhesive disposed between the body and the barrier consists of: (1) a first adhesive disposed throughout the body and having a substantially constant concentration within the body, (2) a second adhesive disposed throughout the barrier and having a substantially constant concentration within the barrier, or (3) a first adhesive disposed throughout the body and having a substantially constant concentration within the body and a second adhesive disposed throughout the barrier and having a substantially constant concentration within the barrier.

2. The sheathing assembly of claim 1, wherein a peel strength between the barrier and the body is at least 0.0009 kgf/cm to about 2 kgf/cm, as measured according to ASTM D6862.

3. The sheathing assembly of claim 1, wherein the sheathing assembly is free from any mechanical fastener securing the barrier to the first side of the body.

4. The sheathing assembly of claim 1, wherein the body comprises the first adhesive, and wherein the concentration of the first adhesive within the body varies by less than 5%.

5. The sheathing assembly of claim 4, wherein the barrier comprises the second adhesive, and wherein the concentration of the second adhesive within the barrier varies by less than 5%.

6. The sheathing assembly of claim 5, wherein the first adhesive and the second adhesive are different from one another.

7. The sheathing assembly of claim 1, wherein the barrier comprises a mixture of about 5 wt % to about 95 wt % cellulosic fibers and about 5 wt % to about 95 wt % polymer fibers.

8. The sheathing assembly of claim 7, wherein the polymer fibers are bicomponent fibers having an inner core comprising a first polymer and an outer layer comprising a second polymer, and wherein the first polymer and the second polymer are different from one another.

9. The sheathing assembly of claim 1, wherein the body is particleboard, medium density fiberboard, high density fiberboard, waferboard, or oriented strand board.

10. The sheathing assembly of claim 1, wherein the barrier comprises a cross-woven polyolefin wrap that provides a water and air resistant barrier.

11. The sheathing assembly of claim 1, wherein the barrier comprises a mixture of cellulosic fibers and polymer fibers, wherein the polymer fibers comprise bicomponent fibers, wherein the bicomponent fibers comprise a sheath and a core, wherein the sheath comprises a first polymer and a melt additive, wherein the core comprises a second polymer, wherein the first and second polymers are different, and wherein a melting point of the first polymer is less than a melting point of the second polymer.

12. The sheathing assembly of claim 1, wherein the barrier has a water vapor transmission rate of about 0.1 g/m²/24 hrs to about 9.0 g/m²/24 hrs as measured according to ASTM E96 procedure A, wherein the barrier has a dry coefficient of friction of about 0.5μ to about 2.5μ, as measured according to ASTM F1679-04, and wherein the barrier has a wet coefficient of friction from about 0.5μ to about 2.5μ as measured according to ASTM C1028-07e1.

13. The sheathing assembly of claim 1, wherein the barrier comprises a non-woven sheet comprising a mixture of cellulosic fibers and polymer fibers, wherein the cellulosic fibers are present in an amount of about 5 wt % to about 95 wt %, based on the combined weight of the cellulosic fibers and the polymer fibers.

14. A sheathing assembly, comprising:
a body comprising a plurality of lignocellulosic substrates and an adhesive, wherein a concentration of the adhesive is substantially constant throughout the body; and
a barrier comprising a mixture of cellulosic fibers and polymer fibers secured to a first side of the body, wherein the cellulosic fibers are present in an amount of about 5 wt % to about 95 wt %, based on the combined weight of the cellulosic fibers and the polymer fibers, wherein the polymer fibers comprise bicomponent polymer fibers, wherein any adhesive disposed between the body and the barrier consists of: (1) the first adhesive, (2) a second adhesive disposed throughout the barrier and having a substantially constant concentration within the barrier, or (3) the first adhesive and a second adhesive disposed throughout the barrier and having a substantially constant concentration within the barrier, and wherein a peel strength between the barrier and the body is at least 0.0009 kgf/cm to about 2 kgf/cm, as measured according to ASTM D6862.

15. The sheathing assembly of claim 15, wherein the body is particleboard, medium density fiberboard, high density fiberboard, waferboard, or oriented strand board, wherein the adhesive comprises an isocyanate resin, an aldehyde based resin, an oxidative binder, or any mixture thereof, wherein the bicomponent fibers comprise a sheath and a core, wherein the sheath comprises a first polymer and a melt additive, wherein the core comprises a second polymer, wherein the first and second polymers are different, and wherein a melting point of the first polymer is less than a melting point of the second polymer.

16. The sheathing assembly of claim 15, wherein the non-woven sheet has a thickness of about 0.1 mm to about 1.0 mm, wherein the barrier has a water vapor transmission rate of about 0.1 g/m²/24 hrs to about 9.0 g/m²/24 hrs as measured according to ASTM E96 procedure A, wherein the barrier has a dry coefficient of friction of about 0.5μ to about 2.5μ, as measured according to ASTM F1679-04, and wherein the barrier has a wet coefficient of friction from about 0.5μ to about 2.5μ as measured according to ASTM C1028-07e1.

17. A method for making a sheathing assembly, comprising:
locating a barrier and a body proximate one another, wherein the body comprises a plurality of lignocellulosic substrates; and
pressing the barrier and the body together to at least partially secure the barrier to the body to form a sheathing assembly, wherein any adhesive disposed between the body and the barrier consists of: (1) a first adhesive disposed throughout the body and having a substantially constant concentration within the body, (2) a second adhesive disposed throughout the barrier and having a substantially constant concentration within the barrier, or (3) a first adhesive disposed throughout the body and having a substantially constant concentration within the body and a second adhesive disposed throughout the barrier and having a substantially constant concentration within the barrier.

18. The method of claim 17, wherein a peel strength between the barrier and the body is at least 0.0009 kgf/cm to about 2 kgf/cm, as measured according to ASTM D6862.

19. The method of claim 17, wherein the body comprises the first adhesive, and wherein the concentration of the first adhesive within the body varies by less than 5%.

20. The method of claim 17, wherein the barrier comprises a mixture of about 5 wt % to about 95 wt % cellulosic fibers and about 5 wt % to about 95 wt % polymer fibers wherein the polymer fibers are bicomponent fibers having an inner core comprising a first polymer and an outer layer comprising a second polymer, and wherein the first polymer and the second polymer are different from one another.
